(19) United States
(12) Patent Application Publication
(10) Pub. No.: US 2004/0062378 A1
(43) Pub. Date: Apr. 1, 2004

(54) Device and method for characterizing the transmission parameters of a transmission link for high bit rate data transmission

(76) Inventors: Chlodwig Neuhäusler, W?ouml;rthsee (DE); Hans-Werner Rudolf, Saverne (FR)

Correspondence Address: NEIFELD IP LAW, PC, 2001 JEFFERSON DAVIS HIGHWAY, ARLINGTON, VA, 22202, US

(21) Appl. No.: 10/432,636

(22) PCT Filed: Jan. 25, 2002
(86) PCT No.: PCT/DE02/00261

(30) Foreign Application Priority Data
Feb. 16, 2001 (DE) 10107438.7

(51) Int. Cl. H04M 5/00; H04M 3/00

(52) U.S. Cl. 379/242

(57) ABSTRACT

The invention relates to a method for determining the transmission parameters of a transmission link for high bit rate data transmission, wherein the transmission link consists of a line module (1) in a switching centre, a subscriber modem (2) and a subscriber connection line (3) for connecting the line module (1) and the modem (2). The invention also relates to a line module (1) for high bit rate data transmission for a switching centre and a modem (2) for high bit rate data transmission for a subscriber in order to carry out said method.

The present invention relates to a line module for a switching center, a modem for high bit rate data transmissions for use with this line module by a subscriber, and a method used in this line module and modem for characterizing the transmission parameters between the line module and the modem.

Modern switching centers in the digital electronic switching system (EWSD) are already capable of providing to subscribers with their terminal equipment not only the conventional analog (POTS, Plain Old Telephone System) or digital (ISDN, Integrated Services Digital Network) telephone services, but also high bit rate data transmission services within the xDSL transmission system (x Digital Subscriber Line).

The ADSL transmission system (Asymmetric DSL), for example, permits a data transmission rate from the switching center to the subscriber (Data Downstream) of up to 8 Mbit per second, and in the opposite direction (Data Upstream) of up to 640 kbit per second.

The interface between the subscriber and the switching center or telecommunication network, as applicable, comprises a so-called line module (also referred to as a subscriber line module, linecard or SLMI—Subscriber Line Module Internet) in the switching center.

In general, several subscribers are connected to one line module, each via one subscriber line with its terminal devices (e.g. telephone and PC); here, both services are transmitted between the subscriber and switching center over one physical line. At the subscriber's site, the services are separated out into data services and telephone services by a so-called splitter. For high bit rate data transmissions, the PC provides an appropriate xDSL modem. The totality of the terminal devices at the subscriber end (telephone, PC with xDSL modem and splitter) is also referred to as the Customer Premises Equipment (CPE).

In this situation, data is transmitted in various frequency ranges, with each frequency range representing a separate transmission channel for data transmission; the data for telephone services is transmitted in one frequency range, the data for data transmissions from the subscriber to the switching center (data upstream) in a second frequency range, and the data for data transmissions from the switching center to the subscriber (data downstream) in a third frequency range.

The line modules described have an integrated voice/data chipset, which permits both the transmission of speech over a voice network using the PCM (Pulse Code Modulation) system and also the transmission of data (e.g. using the Frame Relay, Ethernet or ATM system) for packet-oriented data transmission over a data transmission network (e.g. the Internet) at high data transmission rates.

As part of their manufacturing process and during the operation of xDSL modules, such as modems and line modules in an ADSL or UDSL data transmission system, in order to ensure the functionality of the xDSL modules or the transmission line (subscriber line), it is necessary to check such transmission parameters as, for example, the amplitude frequency response of the transmit/receive interface (Line Transceiver) of the module concerned and of the connecting subscriber line.

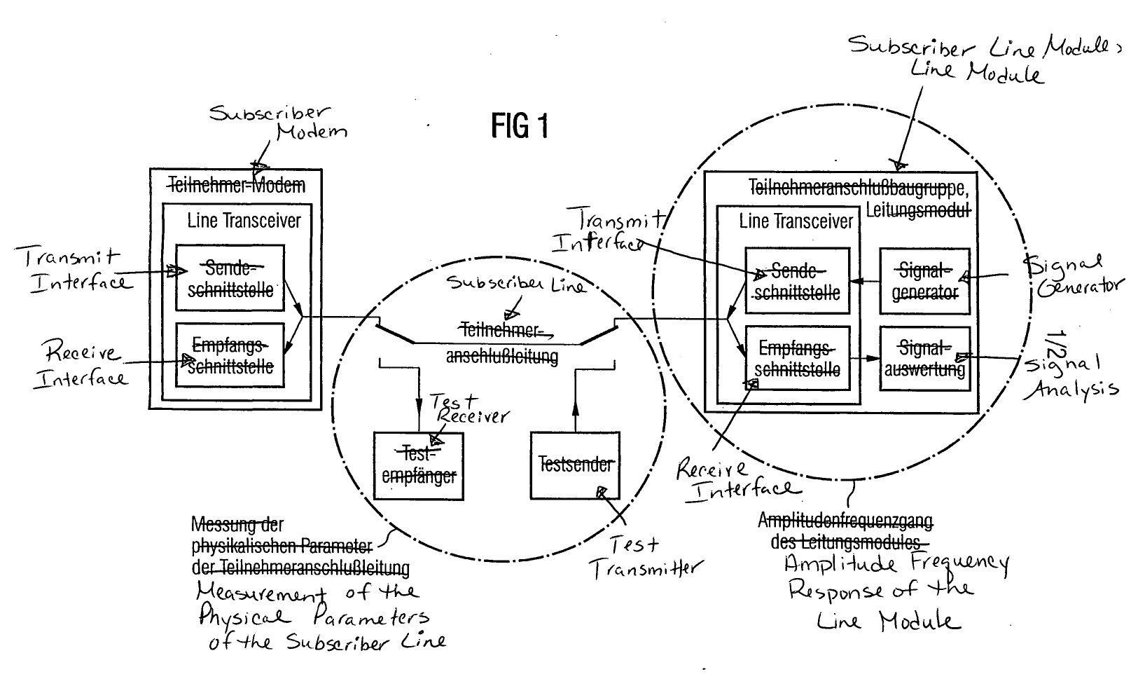

With the prior art, this problem has been solved by measuring the physical parameters of the subscriber line (FIG. 1) after disconnecting the terminal devices (xDSL modem and line module). However, the disadvantage of this method is that it requires one technician at the switching center end and another at the subscriber site end, who attach and operate the appropriate test devices (test transmitter and test receiver). In addition, using this method it is only possible to check the transmission parameters of the subscriber line.

In addition, a method has been disclosed, the use of which enables the amplitude frequency response of an xDSL line module to be determined and analyzed at the module level without supplementary measuring tools (FIG. 1); this “Method for characterizing the amplitude frequency response of an xDSL line transceiver” is described by Siemens AG in the Patent Application with application file number 100 22 710.4.

The international application WO 99/14921 discloses a system, a test device and a method for testing an xDSL transmission over a telephone line. With this, a so-called test signature is sent out, and is received by a test device. This latter analyzes the test sequence received, and indicates or issues a signal, as applicable, as to whether the line is suitable for xDSL transmissions. This information is in purely binary form, the only check which is made is whether the line can or cannot transmit xDSL signals, i.e. it specifies either a pass or a fail state.

In addition, the international application WO 00/38371 discloses a method and system for reducing blocking in connection-oriented packet networks with DSL connections. This tests the DSL connections for their maximum transmission data rate. This test is performed by raising the data rate to the customer end step by step in the switching center. When the customer end is no longer able to answer or if a so-called “fail” signal is generated by the customer end, then the data rate is not increased any further, and the last error-free transmission rate is saved as the highest maximum data rate. This value is determined purely from the switching center end.

International application WO 99/39498 discloses a splitter for separating telephone and DSL signals, which contains measuring tools. Using this splitter, it is possible to check a connecting line between a switching center and a customer to see if it is suitable for DSL transmission.

However, no method has yet been disclosed for determining in a single operation the transmission parameters for data transmissions between an xDSL modem, subscriber line and line module.

The object of the present invention is thus to provide a method for determining the transmission parameters of a transmission link for high bit rate data transmissions, and a line module and a modem for carrying out this method, using which it is possible to make a simple determination of the transmission parameters of the transmission link between the modem, subscriber line and line module, and which makes available the transmission parameters for further analysis and processing.

This object is achieved by a method for determining the transmission parameters of a transmission link for high bit rate data transmissions in accordance with the attached Claim 1, a line module in accordance with the attached Claim 8 together with a modem in accordance with the attached Claim 11.

In accordance with the present invention, the xDSL modem and the line module are actively incorporated into the measurement operation used to determine the parameters of the transmission link for high bit rate data transmissions. The measurement operation thus extends to the modem, the subscriber line and the line module.

For this purpose, the line module in accordance with the invention provides a line module test transmitter for generating first test signals and for sending these test signals to a modem.

The modem in accordance with the invention receives these first test signals using a modem test receiver. A modem analysis device analyzes the first test signals in relation to the transmission parameters of the transmission link or transmission channel, as applicable, from the line module to the modem. After this, a modem protocol transmitter transmits a test protocol to the line module. This test protocol contains the analysis of the first test signals; the line module receives the test protocol using a line module protocol receiver.

For the purpose of determining the transmission parameters from the modem to the line module, the modem according to this invention provides a modem test transmitter. This modem test transmitter generates and sends second test signals to the line module in the switching center. For this purpose, the line module provides a line module test receiver. The analysis of these test signals with respect to the transmission parameters of the transmission link or transmission channel, as applicable, from the modem to the line module, is carried out by a line module analysis device.

This enables the transmission parameters to be determined for both directions (modem to line module and vice versa), separately or in a single measurement operation.

The advantage of the present invention consists in the fact that the measurements on the transmission link then only require one technician, located in the switching center. The technician issues a test job for the transmission link to a particular subscriber, whereupon the measurement is automatically made.

Furthermore, this permits the transmission parameters for the entire transmission link, the modem, the subscriber line and the line module, to be determined in a single operation.

This reduces the effort required for the commissioning and maintenance of an xDSL transmission link; it then requires neither an external test device nor the deployment of a technician to the subscriber's site.

Advantageous embodiments of the present invention are quoted in the subclaims concerned.

The line module in accordance with the invention contains a communication interface which permits general access to the line module for procedures relating to the measurement operation for determining the transmission parameters.

This communication interface enables the line module analysis device and the line module protocol receiver to be accessed for the purpose of reading out the analyses of test signals. Furthermore, this communication interface enables the line module test transmitter and line module control transmitter to be accessed in order to initialize and carry out a test job for the modem and the line module and/or to update the measurement routines stored in the modem or the line module, as applicable.

In such cases the access may be made manually, for example, by a technician who makes a qualitative assessment of the transmission link on the basis of the transmission parameters determined. In addition, the access can also be made automatically by a computer program, for example at regular intervals or if there is an increased incidence of errors.

The possibility for the line module to update the test routines in the modem ensures that it is possible to make flexible adaptations for changing requirements with respect to the types of test, depth of testing etc.

Since the transmission parameters, in particular the available bandwidth, are not know in advance, it is logical to carry out the data transmission for the test protocol using as low a data transmission rate (bit rate) as possible. This ensures that it is possible in every case to make a data transmission, even on a subscriber line which is damaged or has restricted functional capabilities with a restricted transmission bandwidth. One conceivable example here is a frequency range which lies as near as possible to the start of the frequency range for the data upstream transmission channel and corresponds roughly to the bandwidth for speech transmission (4 kHz). However, another conceivable example here is a data transmission within the frequency range in which the transmission of telephone services normally takes place.

The modem provides in addition a modem control receiver. This modem control receiver receives from the line module the data which contains an initialization of the modem for a test job and/or the updates of the measurement routines stored in the modem. These items of data are processed by the modem control receiver, whereupon the appropriate actions (initialization or updating, as applicable) are initiated in the modem.

In the simplest case, the first and second test signals exchanged between the line module and the modem are sinusoidal signals, which in each case can be tuned (varied) within a particular frequency band. In this way, the analysis devices concerned can very easily determine the amplitude frequency response of the transmission link from the switching center (line module) to the subscriber (modem) and vice versa.

The test signals can also be multi-tone signals containing a particular frequency spectrum.

The analysis devices concerned carry out a spectral analysis of the test signals, which can be used very simply to determine the amplitude frequency response.

It is also conceivable for the transmission parameters to be determined by the transmission of test signals in one transmission direction only. In this case, for example, the line module generates a first test signal, covering the entire transmission range (data upstream and data downstream). The analysis is carried out, as described, in the modem, which sends a test protocol to the line module for further processing. The determination could also be made in the reverse transmission direction. In this way, the test signals then only need be analyzed by one device (modem or line module).

The present invention will be explained in more detail below on the basis of a preferred exemplary embodiment and by reference to the attached drawings, where:

FIG. 1 shows a representation of the test procedure in accordance with the prior art,

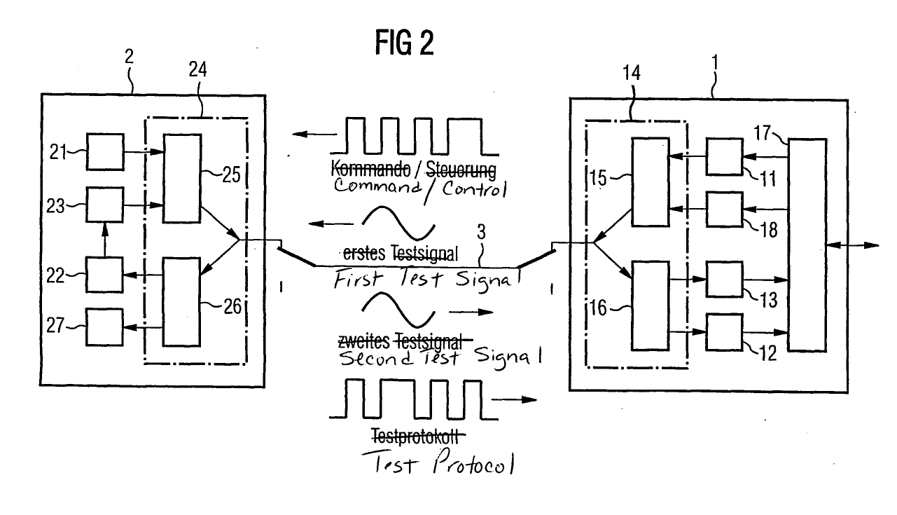

FIG. 2 is a representation of the transmission link in accordance with the present invention.

The present invention is explained below in more detail by reference to FIG. 2, which shows a schematic representation of the transmission link.

The transmission link which is addressed by the present invention consists of a line module 1 in the switching center, a modem 2 (xDSL modem) on the subscriber's premises, and the subscriber line 3 which connects the subscriber to the switching center. The subscriber line 3 is shown in the diagram as disconnectable so that, for example, it is possible to make measurements solely for this line, as with the prior art.

The line module 1 contains, among other items, the line module test transmitter 11, the line module analysis device 12, the line module protocol receiver 13, the communication interface 17 and the line module control transmitter 18. In addition, the line module 1 contains a transmit/receive device 14, which in turn consists of the line module transmission interface 15 and the line module reception interface 16, for connecting the subscriber line 3 to the line module 1, for transmitting and receiving data.

The modem 2 contains, among other items, the modem test transmitter 21, the modem analysis device 22, the modem protocol transmitter 23, and the line module control receiver 27. In addition, the modem 2 contains a transmit/receive device 24, which in turn consists of the modem transmission interface 25 and the modem reception interface 26, for connecting the subscriber line to the modem 2, for transmitting and receiving data.

For the determination (measurement) of the amplitude frequency response from the line module 1 to the modem 2 (data downstream), there is a signal generator (line module test transmitter 11) in the line module, which generates a signal (first test signal), the spectral components of which lie within the desired frequency band for the data downstream data transmission.

The modem 2 on the subscriber's premises is initialized by the modem control receiver 27, as the receiver of the first test signal, using an initialization procedure which is started via the communication interface 17 and sent via the line module control transmitter 18. This sets up the modem analysis device 22 as a spectral analyzer. Using this, the modem 2 determines the amplitude values of the spectral components expected in the first test signal it has received (and hence the base points for the data downstream amplitude frequency response).

The modem protocol transmitter 23 then codes the spectral components in a test protocol (measurement protocol) and sends them to the line module 1 for further analysis, where they are received by the line module protocol receiver 13. As a result, the test protocol is available for further analysis, via the communication interface 17.

For the measurement of the amplitude frequency response in the reverse direction (data upstream), the initialization procedure is used to initialize the modem 2 as a signal generator. In doing so, the modem test transmitter 21 sends to the line module a second test signal, containing the spectral components of the frequency desired in the data upstream direction.

After the test cycle has started the line module 1 uses the line module analysis device 12, which is also set up as a spectral analyzer, to analyze the amplitude values of the expected spectral components of the second test signal, and hence determines the base points for the data upstream frequency response.

To implement the present invention, the line module 1 and also the modem 2 each contain implementations of DSP algorithms (Digital Signal Processing), which enable the test signals to be generated for the test transmitter concerned, or the test signals received to be analyzed (e.g. spectral analysis) by the analysis device concerned.

In each case, the measurement is initiated in the switching center by a single technician who can access the line module 1 using the communication interface 17. The technician issues a test job for a particular subscriber line (modem 2, subscriber modem), whereupon the line module establishes contact with the subscriber modem 2 via the test protocol, and makes the necessary initializations and settings.

For test runs in which the line module 1 acts as the source of the test signal (first test signal) and the subscriber modem (modem 2) as the receiver, the analysis of the test signals received is carried out in the modem itself. The actual test results are communicated to the line module 1, in the form of a measurement protocol (test protocol), so that they are then available to the technician in the exchange for further analysis via the communication interface 17.

For test runs in which a test transmitter is required at the subscriber end (modem test transmitter 21), this function is performed by the subscriber modem after appropriate initialization by the line module 1. The second test signal which is then received by the line module is analyzed and made available to the technician in edited form.

The present invention makes possible a particularly flexible method of measurement for testing the specified transmission link.

Thus it is possible to make noise measurements and spectral measurements in arbitrarily selected frequency and spectral ranges. In addition, it is possible to conceive of event-controlled measurements, when particular threshold values are exceeded. An example of such a threshold value is bit errors, for which a report is sent back to the switching center by the modem 2 or the line module 1 if a particular bit error rate is exceeded, whereupon a measurement is automatically initiated.

A further possibility is a data upstream line qualification over the entire data downstream bandwidth for the nominated transmission link. The proposal from Siemens AG in the Patent Application with application file number 100 22 710.4 for a “Method for characterizing the amplitude frequency response of an xDSL line transceiver” is particularly advantageous for this measurement.

The test results determined can serve, for example, for the qualitative assessment of the transmission link by a technician, e.g. for fault-finding and fault localization, for setting prescribed parameters for the transmission link concerned, etc.

List of Reference Characters

1 Line module, subscriber line module

11 Line module test transmitter

12 Line module analysis device

13 Line module protocol receiver

14 Line module transmit/receive device, line module transceiver

15 Line module transmit interface

16 Line module receive interface

17 Communication interface

18 Line module control transmitter

2 Modem

21 Modem test transmitter

22 Modem analysis device

23 Modem protocol transmitter

24 Modem transmit/receive interface, modem line transceiver

25 Modem transmit interface

26 Modem receive interface

27 Modem control receiver

3 Subscriber line

1. Method for determining the transmission parameters of a transmission link for high bit rate data transmission, where the transmission link comprises a line module (1) in a switching center, a modem (2) at a subscriber site, and a subscriber line (3) to connect between the line module (1) and the modem (2), and by which the following steps are carried out:
the generation of first test signals by the line module (1) and the sending of these first test signals to the modem (2), with the first test signals being used to determine the transmission parameters of a transmission channel from the switching center to the subscriber,
the receiving and analysis of the first test signals by the modem (2),
the generation of second test signals by the modem (2) and the sending of these test signals to the line module (1), with the second test signals being used to determine the transmission parameters of a transmission channel from the subscriber to the switching center,
the receiving and analysis of the second test signals by the line module (1),
the generation of a test protocol by the modem (2) and the sending of this test protocol to the line module (1), with the test protocol containing an analysis of the first test signals, and
the receiving and analysis of the test protocol by the line module (1).

2. Method in accordance with claim 1, characterized in that
the test protocol and the analysis of the second test signals are available via a communication interface for further processing and analysis.

3. Method in accordance with claim 1 or 2, characterized in that
data, which contains an initialization of the modem (2) for a test job and/or an update of the measurement routines stored in the modem (2), is sent from the line module to the modem (2).

4. Method in accordance with claim 1, 2 or 3, characterized in that
the data for the test protocol, for the initialization for a test job, and for updating the measurement routines, is transmitted at a low data transmission rate.

5. Method in accordance with one of the claims 1 to 4, characterized in that
the test signals are sinusoidal signals, which are tuned over a particular frequency range, to determine the amplitude frequency response of the subscriber line in combination with the modem and the line module.

6. Method in accordance with one of the claims 1 to 5, characterized in that
the test signals are multi-tone signals, to determine the amplitude frequency response of the subscriber line (3) in combination with the modem (2) and the line module (1).

7. Method in accordance with claim 5 or 6, characterized in that
the test signals received are subject to a spectral analysis.

8. Line module (1) for carrying out the method in accordance with one of the claims 1 to 7 for a switching center, for connecting a modem (2) to a telecommunications network for high bit rate data transmission, where the connection between
the modem (2) and the line module (1) can be established via a subscriber line (3), and which contains
a line module test transmitter (11) for generating first test signals and for sending these test signals to a modem (2), with the first test signals being used to determine the transmission parameters of a transmission channel from the switching center to the subscriber,
a line module analysis device (12) for receiving and analyzing second test signals, sent by the modem (2), with the second test signals being used to determine the transmission parameters of a transmission channel from the subscriber to the switching center, and
a line module protocol receiver (13) for receiving a test protocol from the modem (2), where the test protocol contains an analysis of the first test signals.

9. Line module (1) in accordance with claim 8, characterized by
a communication interface (17) which makes it possible to access the line module (1) to read out the analyses of the test signals.

10. Line module (1) in accordance with claim 8 or 9, characterized in that
initialization of the modem (2) for a test job, and/or for an up-dating of the measurement routines stored in the modem (2), can be initiated by a line module control transmitter (18) via the communication interface (17).

11. Modem (2) for carrying out the method in accordance with one of the claims 1 to 7 for high bit rate data transmission over a telecommunications network, where the connection between the modem (2) and a line module (1) in a switching center can be established via a subscriber line (3), and which contains
a modem test transmitter (21) for generating second test signals and for sending these test signals to the line module (1), with these second test signals being used to determine the transmission parameters of a transmission channel from the subscriber to the switching center,
a modem analysis device (22) for analyzing first test signals, sent by the line module (1), with these first test signals being used to determine the transmission parameters of a transmission channel from the switching center to the subscriber, and
a modem protocol transmitter (23) for generating and sending a test protocol to the line module (1), where the test protocol contains an analysis of the first test signals.

12. Modem (2) in accordance with claim 11, characterized by
a modem control receiver (27) which receives from the line module, and processes, data containing the initialization of the modem (2) for a test job and/or for an updating of the measurement routines stored in the modem (2).
